(19) United States
(12) Patent Application Publication
(10) Pub. No.: US 2010/0128125 A1
(43) Pub. Date: May 27, 2010

(54) SENSOR NETWORK SYSTEM, TRANSMISSION PROTOCOL, METHOD FOR RECOGNIZING AN OBJECT, AND A COMPUTER PROGRAM

(76) Inventor: Jan Karl Warzelhan, Hildesheim (DE)

Correspondence Address: MICHAEL J. STRIKER, 103 EAST NECK ROAD, HUNTINGTON, NY, 11743, US

(21) Appl. No.: 12/621,233

(22) Filed: Nov. 18, 2009

(30) Foreign Application Priority Data
Nov. 21, 2008 (DE) 10 2008 043954.1

(51) Int. Cl. G06K 9/00; H04N 7/18

(52) U.S. Cl. 348/143; 348/E07.085; 382/103

(57) ABSTRACT

A sensor network system for tracking moving objects within a surveillance region includes a plurality of network nodes, each assigned and/or assignable to a subregion of the surveillance region, in which at least one of the network nodes includes a classifier generator which is programmed and/or electronically configured to train a local classifier to discriminate the moving objects that are relevant in the assigned subregion, and in which network node is designed to forward object information on the moving objects to other network nodes for the purpose of tracking and/or recognizing moving objects that move away from network node and toward the other network nodes, and in which the object information is designed as classifier.

### CROSS-REFERENCE TO A RELATED APPLICATION

The invention described and claimed hereinbelow is also described in German Patent Application DE 10 2008 043 954.1 filed on Nov. 21, 2008. This German Patent Application, whose subject matter is incorporated here by reference, provides the basis for a claim of priority of invention under 35 U.S.C. 119(a)-(d).

### BACKGROUND OF THE INVENTION

The present invention relates to a sensor network system for tracking moving objects within a surveillance region, comprising a plurality of network nodes, each of which is assigned and/or assignable to a subregion of the surveillance region, in which at least one of the network nodes includes a classifier generator which is programmed and/or electronically configured to train a local classifier to discriminate the moving objects that are relevant in the assigned subregion, and in which the network node is designed to forward object information on the moving objects to other network nodes for the purpose of tracking and/or recognizing moving objects that move away from the network node and toward the other network nodes.

The present invention also relates to a transmission protocol, a method for recognizing an object, and a computer program.

Surveillance systems are used in public spaces, public buildings, or other areas to be monitored in order to detect persons or other relevant objects and track them within the surveillance region in a manner which has become automated. Since surveillance regions of this type are highly complex in design and typically include intermediate regions that are not monitored, it is technically challenging to track a moving object from one monitored subregion to the next monitored subregion.

Basically, it is possible to filter a desired moving object out of a large number of moving objects and to recognize it, e.g., by using “classifiers”. Classifiers represent the characteristic space of a set—of all moving objects in the surveillance region, in this case—within a set of classes; the classifiers are often arranged in the form of hierarchies or trees. When a tree-type formation is used, a query object is entered at a root node in a classification tree and is processed up to a leaf node, which is the classification result. Classifiers of this type are adequately known in the field of image processing.

Publication number JP2007-135093 (application number: 2005-327873) discloses a video monitoring system including a large number of cameras which are installed throughout a complex surveillance region and communicate with one another. In this system, information on the moving object, e.g., the object size, speed, direction, color, and type, is transmitted from one camera to a subsequent camera in order to track the object.

### SUMMARY OF THE INVENTION

Accordingly, it is an object of the present invention to provide a sensor network system for tracking moving objects, a transmission protocol for transferring object information, a method for recognizing an object in a sensor network system, and a computer program, which are further improvements of the existing objects of this type.

The present invention relates to a sensor network system, in particular a surveillance system, especially a video surveillance system, for tracking moving objects within a surveillance region. The moving objects may basically have any type of design, e.g., they may be people, but also animals, objects, automobiles, trucks, etc. The surveillance region may also have any type of design, e.g., it may be a two-dimensional region such a street or an intersection, or it may be a three-dimensional region such as a multistoried building.

The sensor network system comprises a plurality of network nodes, each of which is assigned and/or assignable to a subregion of the surveillance region. In this case, the subregions are actual sections of the surveillance region that overlap, but they may also be situated relative to one other such that they do not overlap. Preferably, at least one sensor and preferably a plurality of sensors is assigned to each network node. It is possible, e.g., to use one or more surveillance cameras, or other sensors as an alternative or in addition thereto, e.g., microphones, receivers for electromagnetic radiation, odor sensors, weight sensors, etc. The sensors are suited, designed, and/or located such that they register sensor data in the assigned subregion.

At least one, preferably a few, and in particular all network nodes include a classifier generator and, optionally, a classifier evaluator. The two modules may be integrated in the network node, or they may be connected thereto merely via logic and/or signals.

The classifier generator is designed to train a local classifier for the network node or the subregion assigned to it, the local classifier concentrating on the relevant moving objects in the assigned subregion. The classifier is preferably limited to a subset of all moving objects within the surveillance region, the subset relating to the moving objects that exist in the subregion. “Relevant objects” preferably refers to objects that belong to a certain object type (person, automobile, etc.), and/or which are present or have been present in the subregion for a defined period of time.

The optional classifier evaluator is designed to apply any local classifier or the local classifier of its network node that was trained by the classifier generator on a moving object—which is referred to below as the query object—located in the assigned subregion of the network node.

A classifier preferably refers to a decision hierarchy that is designed to classify moving objects used for training and/or to generate the decision hierarchy, in order to thereby recognize the particular objects.

The network nodes are designed to forward object information on the moving objects to other network nodes, with the objective of tracking objects via at least two network nodes, in particular via the entire network system.

According to the present invention, it is provided that the object information is designed as the local classifier.

A finding of the present invention is that it is nearly impossible or extremely difficult to transmit all of the information on all moving objects collected in the sensor network to all network nodes. If one considers, for example, a sensor network composed of several hundred network nodes and a correspondingly large number of moving objects, then the volume of data to be transmitted is too great. It is therefore problematic to perform object tracking within the entire surveillance region in a technically simply manner. Objects may be described using a large number of features, e.g., using global or local features, it being possible for the features to have a large number of dimensions. As a result, a very large amount of data may be collected on each object, in particular since the object is typically observed over several frames.

By comparison, the present invention discloses a device that transmits classifiers instead of object features, and that limits the classifiers to the subset of moving objects that is or was relevant for the network node that generates or trains the classifier. For example, if only four moving objects are present in the subregion assigned to a network node, the local classifier need only be capable of discriminating between these four objects. The classifier may access all available features of the four objects in order to select individual classifiers. The four objects may have entirely different sizes or colors, and so it is possible to simply discriminate by color or size. The advantage of the present invention is that the classifiers may also be kept very narrow. Therefore, for purposes of recognition, the features are not transmitted, e.g., to another camera or a central device, but rather classifiers are trained locally, e.g., in the camera, that are capable of discriminating only those objects that actually occur or that are relevant. These classifiers may search for a subset of features or even only for dimensions, in order to discriminate the objects that actually occur.

In a specific embodiment of the present invention, it is provided that the network node is designed such that the local classifier is forwarded to other network nodes to which subregions that are adjacent to the subregion of the local classifier in the surveillance region are assigned. The idea behind this specific embodiment is that the moving object either remains in the original subregion, or it moves to a spacially adjacent subregion. In either case, it is always easy to identify the object: The original local classifier finds it in the original subregion, and, in the adjacent subregions, the object is recognized by the transmitting local classifier, likewise in a simple, reliable manner.

In an advantageous embodiment of the present invention, the classifier generator is realized in such a manner that the local classifier is trained on objects that are present or were present and/or that exist or existed in the assigned subregion of the network node within a specifiable time period. For example, objects having an age that exceeds a certain limit are automatically deactivated. In this manner it is possible to keep the classifier lean. Optionally, it is possible, e.g., for purposes of initialization, to use supplemental initialization objects to train the local classifier. For the case in which only a single moving object exists in the assigned subregion, it is recommended that the classifier be trained using this moving object and a specifiable initialization object at the least. The initialization object may be deactivated at a later point in time.

The classifier evaluator is preferably designed to apply the local classifier of its own network node and/or the local classifier(s) of the other network nodes assigned to the adjacent subregions to a query object, i.e., to an object that was discovered by the sensor(s). If it is discovered during the application that the query object is positively detected by its own local classifier, it is assumed that the query object is still located in the same subregion.

It is preferably provided that, when one of the local classifiers of the other network nodes assigned to the adjacent subregions is applied in a positive manner, then the query object is evaluated as having been recognized. In response thereto, a new position or an existing ID, for instance, is assigned to the recognized query object or object. Using this procedure, it is possible to track an object across the entire sensor network system.

As an option, it is provided that, when the query object is recognized by one of the local classifiers of the other network nodes, the network node sends a deactivation alert to the affected network node that transmitted the positively applied classifier. Via this deactivation alert, the network node is informed that the query object has arrived in the subregion of the current network node.

As a possible reaction, it may be provided that the local classifier is retrained or updated when a deactivation alert of this type is received, and/or when a query object from an adjacent network node has been recognized, and/or when a new object has been detected. In each of the aforementioned cases, the set of relevant objects for the local classifier changes, and so it appears reasonable or even necessary to update the classifier.

A further subject matter of the present invention relates to a transmission protocol for transmitting object information from a network node, preferably from a sensor network system according to the preceding claims. The transmission protocol includes local classifiers of moving objects in a subregion of a surveillance region, in which case the local classifiers are transmitted from the network node to other network nodes assigned to subregions which are spacially adjacent to the first network node.

A further subject matter of the present invention relates to a method for recognizing an object in a sensor network system used to monitor a surveillance region, preferably as described above or according to one of the preceding claims, comprising the steps:
Train and/or create a local classifier for a spacial subregion of the surveillance region for the relevant moving objects in the spacial subregion;
Transmit the local classifier to a network node of a spacially adjacent subregion;
Search for one of the relevant moving objects in the subregion of the second network node.

A final subject matter of the present invention relates to a computer program having the features of claim 10.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a schematic block diagram of a network system, as a first embodiment of the present invention;

FIG. 2 shows a depiction of a classifier for use in the network system according to FIG. 1;

FIG. 3 shows a node diagram of the sensor network system according to FIG. 1.

### DESCRIPTION OF THE PREFERRED EMBODIMENTS

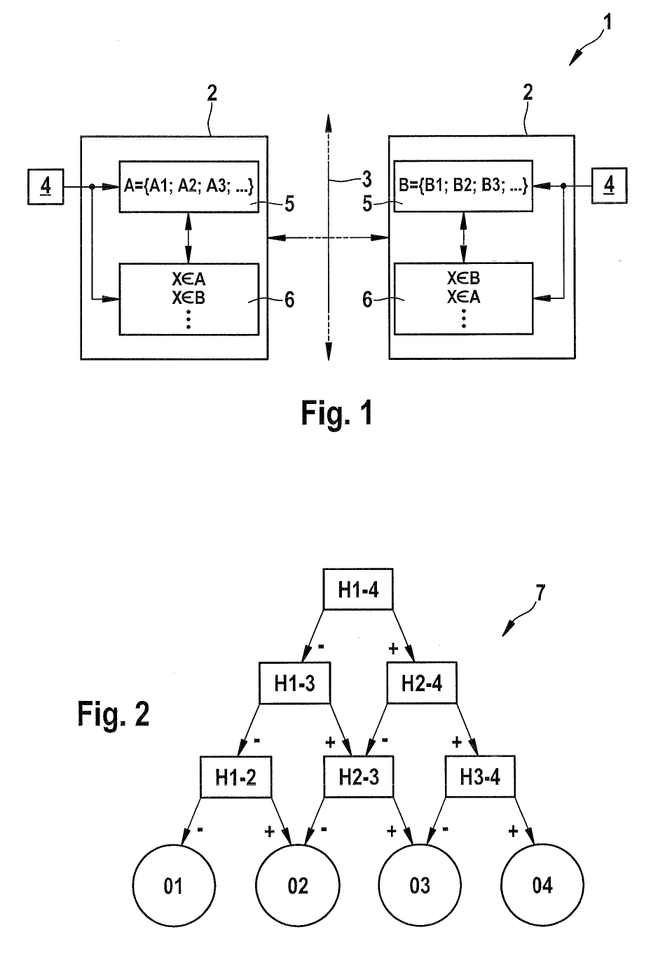

FIG. 1 shows a schematic block diagram of a sensor network system 1 which is suited and/or designed to monitor a surveillance region, e.g., a building, a street, or the like. Sensor network system 1 comprises a plurality of network nodes 2 which are connected and/or are connectable such that they communicate with one another via a network 3. Network 3 may have any type of design, and, in particular, is connected via cable or wirelessly, e.g, as a LAN, WLAN, Internet, etc. Sensor network system 1 may include a large number, e.g., more than 50 or 100, network nodes 2.

Network node 2 is connected to one or more sensors 4; sensors 4 of one of the network nodes 2 are directed to a subregion of the surveillance region assigned to network node 2. Sensor 4 may be designed, e.g., as one or more surveillance cameras, or as a microphone, a weight sensor, a sensor for electromagnetic radiation, etc. Using sensors 4, moving objects such as persons in the assigned subregion are detected, and the sensor data are forwarded to network nodes 2.

A classifier generator 5 is integrated in network node 2, or it is connected to network node 2 via signals; classifier generator 5 is designed to train a classifier 7 (FIG. 2) based on the objects that exist in the assigned subregion. Classifier 7 is limited to discriminating exactly those objects that are present in the assigned subregion; other, real objects in sensor network system 1 or the surveillance region are (initially) ignored. In addition, network node 2 includes a classifier evaluator 6 that is designed to apply classifiers 7 to a query object.

FIG. 2 shows a schematic depiction of a classifier 7 for a limited number of objects; four objects, O1, O2, O3 and O4, are shown as an example. In the embodiment of classifier 7 shown, individual classifiers H1-H4 are trained between pairs of objects. For example, individual classifier H1-2 is designed to discriminate objects O1 and O2. The response of individual classifier H may be negative (=object O1) or positive (=object O2), and redirect accordingly to the left or right branch in the tree of classifier 7.

A query object is always entered at the root node (top) in the classification tree, and then travels through the classification tree until it reaches the leaf node, which is the classification result, in the final row. It is also possible to use other classifiers, as are currently known from the literature.

In FIG. 1, classifier 7 in the two network nodes 2 is depicted once as set A, using set notation, and a second time as set B, in set notation, as follows:

### A={A1; A2; A3; . . . }

### B={B1; B2; B3; . . . },

in which classifier 7: A or B is trained on the objects in the assigned set.

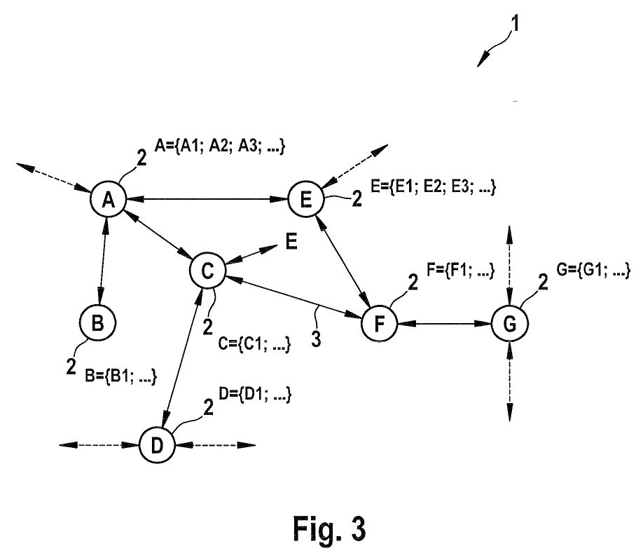

The mode of operation of sensor network system 1 is explained below with reference to the illustration in FIG. 3: FIG. 3 shows sensor network system 1 in a node representation, in which a plurality of network nodes 2 is visualized, which are connected to one another via network 4. FIG. 3 illustrates the signal-based interconnection of network nodes 2, and it depicts the spacial proximity of the subregions in the surveillance region assigned to network nodes 2, and their spacial connections to one another. It is only possible, for instance, to reach the subregion of network node B via the subregion of network node 2: A. The subregion of network node 2: C is reached, however, via an entry point E and the subregions of network nodes 2: A, F and D. The understanding of the topology of sensor network system 1 and the assigned subregions may be learned automatically, for example, or it may be entered manually when network nodes 2 are installed. Each of the network nodes 2: A-G includes a classifier 7 which is depicted in set notation in FIG. 3, in analogy to FIG. 1, and each one is trained on or limited to the objects that are relevant in the assigned subregion.

If a new or apparently new object enters a subregion of network nodes 2: A-G, e.g., network node 2: C, then network node 2: C requests classifiers 7: A, D, F from all network nodes 2, the subregions of which are spacially adjacent to the subregion of network node 2: C (that is, A, D, F). For the case in which a classifier 7 was not created in one of the adjacent network nodes 2: A, D, F before a certain time, e.g., a necessary transfer time between the subregions of the network nodes (plus a certain tolerance time), because there were no objects present, this means it is not possible for the tracked object to come from this direction or from network nodes 2. Network nodes 2: A, D, F, which have created a classifier 7, transmit classifier 7 to requesting network node 2, which is C in this case. Requesting network node 2: C first evaluates its own classifier 7: C; if the result is negative, classifiers 7: A, D, F requested from adjacent network nodes 2 are evaluated. If a classifier 7 describes the object to the required extent, the object has been recognized and, e.g., it may continue to use the ID (identification number) of the object from the transmitting network node 2 (the object has been recognized). If the classification results of all classifiers 7 are below the required level, this means that a new object has been found, and it may be, e.g., an object that entered via entry point E.

In the case of an object A1, which moves from the subregion of network node 2: A to the subregion of network node 2: C, classifiers 7: A, C are modified as follows:

### Deactivate: A={A1; A2; A3; . . . }→A={A2; A3; . . . }

### Add: C={C1; C2; C3; . . . }→C={A1; C1; C2; C3; . . . }.

In the case of a new object E1, which first enters the surveillance region of sensor network 1 via entry point E in the subregion of network node 2: C, only classifier 7: C is modified:

New addition: C={C1; C2; C3; . . . }→C={E1; C1; C2; C3; . . . }.

When sensor network system 1 is started up, sensor network system 1 may experience an initialization problem if no objects are present, or if the number of objects is insufficient. One possible way to counteract this is to specify to network node 2 a random initialization object composed of random features of all sensors 4. A new object that appears is then trained relative to this initialization object, in order to therefore have at least two objects to use to train classifier 7. If further objects subsequently appear in the subregion of the same network node 2, the initialization object may be disregarded (deactivated), and classifier 7 is now trained using real objects.

It is possible to solve a “similarity” problem between two objects (are the objects the same or different?) in the same network node 2. It is possible to use known methods within a network node 2, and it is preferable to use all features of the objects to be compared. For example, and preferably, if apparently new objects appear, a check is carried out first based on a majority or all of the features to determine whether this is indeed a new object in the subregion assigned to network node 2, and not an object that has already been analyzed, and that has already been used to train local classifier 7. Only then are classifiers 7 of network nodes 2 of adjacent subregions used.

Particularly advantageously, the system may be used in decentralized hardware, e.g., in smart cameras, since very little memory is required to transmit classifiers 7.

In summary, the potential advantages of the present invention are that it reduces the complexity of the problem of recognizing objects by focusing on locally occurring objects and attempting to discriminate them exclusively. In the method described herein, classifiers 7 are trained specifically on the objects that appear in a network node 2 in sensor network system 1, in order to distinguish them as well as possible. In contrast to classifiers 7 (or procedures in general) that must distinguish between all objects that appear, complexity is thereby reduced and robustness is simultaneously increased, since it is only necessary to discriminate a few objects.

It will be understood that each of the elements described above, or two or more together, may also find a useful application in other types of constructions and methods differing from the types described above.

While the invention has been illustrated and described as embodied in a sensor network system, transmission protocol, method for recognizing an object, and a computer program, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A sensor network system for tracking moving objects within a surveillance region, comprising a plurality of network nodes each assigned and/or assignable to a subregion of the surveillance region; and a classifier generator provided in at least one of the network nodes, the classifier generator being programmed and/or electronically configured to train a local classifier to discriminate the moving objects that are relevant in the assigned subregion, wherein the network node is designed to forward object information on the moving objects to other network nodes for tracking and/or recognizing moving objects that move away from the network node and toward other network nodes, and wherein the object information is configured as the local classifier.

2. The sensor network system as defined in claim 1, wherein the network node is configured to forward the local classifier to the other network nodes to which adjacent subregions in the surveillance region are assigned.

3. The sensor network system as defined in claim 1, wherein the classifier generator is configured to train the local classifier on the objects and on any initialization objects that may be added as an option, that are present and/or that exist in the assigned subregion within a specifiable time period.

4. The sensor network system as defined in claim 1, further comprising a classifier evaluator which is programmed and/or electronically configured to apply the local classifier or the local classifiers to a moving object in the assigned subregion.

5. The sensor network system as defined in claim 4, wherein the classifier evaluator is configured to apply the local classifier of its own network node and/or the local classifiers of other network nodes to a query object.

6. The sensor network system as defined in claim 5, wherein the network node is configured to evaluate the query object as having been recognized if the query object has been recognized by one of the local classifiers of the other network nodes.

7. The sensor network system as defined in claim 5, wherein the network node is configured to transmit a deactivation alert to affected network nodes in order to deactivate the query object from the classifier when the query object has been recognized by one of local classifiers of the other network nodes.

8. The sensor network system as defined in claim 1, wherein the network node is configured to retrain and/or update the local classifier upon receipt of a deactivation alert and/or after a query object from an adjacent network node has been recognized and/or when a new object has been detected.

9. A transmission protocol for transferring object information from a network node according to claim 1, wherein the transmission protocol is configured so that local classifiers of moving objects in a subregion of a surveillance region are transmitted via the transmission protocol from the network node to other network nodes to which adjacent subregions are assigned.

10. A transmission protocol as defined in claim 9, wherein the transmission protocol is configured for transferring object information from a sensor network system including the network node.

11. A method of recognizing an object in a sensor network system according to claim 1, the method includes the steps of training/creating a local classifier for a subregion containing moving objects; transmitting the local classifier to an adjacent network node; and searching by the adjacent network node for one of the moving objects within its own subregion.

12. A computer program comprising program code means for carrying out all steps of the method defined in claim 11, when the program is run on a unit selected from the group consisting of a computer, a sensor network system as defined in claim 1, and both.
